(19) United States
(12) Patent Application Publication
(10) Pub. No.: US 2018/0346042 A1
(43) Pub. Date: Dec. 6, 2018

(54) VEHICLE HITCH MOUNTING TRAILER

(71) Applicant: Yakima Products, Inc., Lake Oswego, OR (US)

(72) Inventors: John Mark Elliott, Beaverton, OR (US); Kevin Lesley, Beaverton, OR (US); Lyle Andrew Ramsdell, Columbia City, OR (US); Patrick T. McKinney, Portland, OR (US)

(73) Assignee: Yakima Products, Inc., Lake Oswego, OR (US)

(21) Appl. No.: 15/996,367

(22) Filed: Jun. 1, 2018

Related U.S. Application Data
(60) Provisional application No. 62/513,886, filed on Jun. 1, 2017.

(51) Int. Cl. B62D 63/06; B62D 63/08; B62D 21/04; B62D 33/02; B60D 1/54; B60G 3/00

(52) U.S. Cl. CPC B62D 63/064; B62D 63/08; B62D 21/04; B62D 33/0207; B60D 1/66; B60G 3/00; B60D 2001/544; B60G 2200/10; B60G 2300/04; B60D 1/54

(57) ABSTRACT

A trailer is disclosed, including a tongue portion configured for connection to a tow hitch of a vehicle, and a spine portion connected to the tongue portion. The trailer further includes a frame structure with a plurality of lower crossbar members transversely connected to the spine portion. The lower crossbar members define a first cargo support level. A plurality of upper crossbar structures are connected to the frame structure above the first cargo support level, and define a second cargo support level elevated above the first cargo support level.

### CROSS-REFERENCES

This application claims the benefit under 35 U.S.C. § 119(e) of the priority of U.S. Provisional Patent Application Ser. No. 62/513,886 filed Jun. 1, 2017, the entirety of which is hereby incorporated by reference for all purposes.

### FIELD

This disclosure generally relates to vehicle trailers. Specifically, it relates to trailers equipped for connection to a hitch receiver on the back of a vehicle, and configured to carry various types of cargo.

### INTRODUCTION

Various types of outdoor sporting activities are becoming increasingly popular. Many of these activities require equipment that will not fit in a typical vehicle or may cause damage if transported inside a vehicle. Such equipment may include watercraft, bicycles, kayaks and the like. Racks are available for transporting some items on top of or behind a vehicle, but these racks may have limitations. For example, a bicycle or a boat may be difficult for an individual to load on top of a vehicle. Other equipment may simply be too large or cumbersome for a conventional vehicle rack. Conventional vehicle cargo racks may also lack the capacity to carry large quantities of equipment, supplies, or materials in a single trip. Trailers may be useful in these situations. However, there is a need for trailers that are more versatile, that can carry different types and combinations of cargo over different ground surfaces, and that are adapted for efficient storage.

### SUMMARY

The present disclosure provides systems, apparatuses, and methods relating to vehicle trailers. In some examples, a trailer may include a tongue portion configured for connection to a tow hitch of a vehicle, and a spine portion connected to the tongue portion. The trailer may further include a frame structure with a plurality of lower crossbar members transversely connected to the spine portion. The lower crossbar members may define a first cargo support level. A plurality of upper crossbar structures may be connected to the frame structure above the first cargo support level, and define a second cargo support level elevated above the first cargo support level.

In some examples, a trailer may include a tongue portion configured for connection to a tow hitch of a vehicle, and a spine portion connected to the tongue portion. The trailer may further include a frame structure with a plurality of lower crossbar member transversely connected to the spine. The lower crossbar members may define a first cargo support level. Each of the lower crossbar members may have opposing end portions connected to side strut members rising to connection with a pair of upper side rail portions on opposing sides of the frame structure.

In some examples, a trailer may include a tongue portion configured for connection to a tow hitch of a vehicle, and a spine portion connected to the tongue portion. The trailer may further include a frame structure including font and back upward U-shaped portions connected to the spine portion. The front and back U-shaped portions may be connected to a pair of side rails, and a pair of crossbars may be mounted on the side rails.

Features, functions, and advantages may be achieved independently in various examples of the present disclosure, or may be combined in yet other examples, further details of which can be seen with reference to the following description and drawings.

### BRIEF DESCRIPTION OF THE DRAWINGS

FIG. 1 is a perspective view of an illustrative double-decker trailer in accordance with aspects of the present disclosure, the trailer loaded with cargo and towed by a vehicle.

FIG. 2 is an isometric view of the trailer shown in FIG. 1.

FIG. 3 is a rear view of the trailer shown in FIG. 1.

FIG. 4 is a partial isometric view of a crossbar and an adjustable clamp device of the trailer shown in FIG. 1.

FIG. 5 is side view of the trailer shown in FIG. 1.

FIG. 6 is a partial isometric view of the hinge device of the trailer shown in FIG. 1, in a closed position.

FIG. 7 is a partial isometric view of the hinge device shown in FIG. 6, in an open position.

FIG. 8 is another perspective view of the trailer shown in FIG. 1, the trailer loaded with five bicycles on the upper deck and two kayaks on the lower deck.

FIG. 9 is a top view of the trailer shown in FIG. 1, the upper crossbars of the trailer removed and four bicycles loaded on the lower deck.

FIG. 10 is a perspective view of the trailer shown in FIG. 1, the trailer parked and supporting a roof-top tent.

FIG. 11 is an isometric view of an illustrative single-decker trailer in accordance with aspects of the present disclosure.

### DESCRIPTION

Various aspects and examples of a vehicle hitch mounting trailer, as well as related systems and methods, are described below and illustrated in the associated drawings. Unless otherwise specified, a vehicle hitch mounting trailer according to the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

### Definitions

The following definitions apply herein, unless otherwise indicated.

Directional terms “longitudinal” and “lateral” should be understood relative to a direction of travel of the trailer or trailers described herein. Longitudinal may indicate a direction along the direction of travel, while lateral may indicate a direction perpendicular to the direction of travel.

The terms “inboard,” “outboard,” “forward,” and “aft” (and the like) are also intended to be understood in the context of the trailers described herein. For example, “outboard” may indicate a relative position that is laterally farther from a centerline of a trailer, or a direction that is away from the trailer centerline. Conversely, “inboard” may indicate a direction toward the centerline, or a relative position that is closer to the centerline. In the absence of the trailer, the same directional terms may be used as if the vehicle were present. For example, even when viewed in isolation, a crossbar may have a “forward” edge, based on the fact that the crossbar would be installed with the edge in question facing in the direction of the front portion of the trailer.

### Overview

In general, a trailer according to the present teachings may include a hitch mount coupled to a central spine, and a plurality of crossbars generally perpendicular to the spine. The trailer may be configured for towing behind a vehicle, and may include two or more wheel assemblies. The trailer may be configured to comply with road safety regulations. For instance, the trailer may include wiring for brake and indicator lights, compatible with a standard vehicle hitch wiring plug.

The trailer may include two decks or levels, one disposed above the other. Each level may include a set of two or more crossbars of the plurality of crossbars. The two levels may be referred to as upper and lower levels, and may define an open interior space. Each of the upper and lower levels may be configured to carry cargo. The interior space may be free of obstruction, to allow passage and storage of cargo.

The set of crossbars of the lower level may be part of a frame structure connected to the trailer spine. The frame structure may also include side bars and side rails, extending generally parallel to the spine. In some examples, the frame structure may be collapsible. For instance, the crossbars of the lower level may be hinged and fold in to extend parallel to the spine and side rails in a storage configuration. The frame structure may be unitary, or may include sub-frame assemblies. For example, the frame structure may be configured for shipment or storage as aluminum sub-frame assemblies, the sub-frame assemblies then being fastened together by a user of the trailer.

Side rails of the frame structure may support the set of crossbars of the upper level. First and second ends of each upper crossbar may be coupled to a respective side rail by a clamp device. Each clamp device may be selectively securable in a plurality of lateral and longitudinal positions. The clamp devices may allow longitudinal adjustment of the upper crossbars along the side rails. The clamp devices may also allow lateral adjustment of the coupled crossbars relative to the frame structure. Some or all of the set of crossbars of the upper level may also be removable.

The plurality of crossbars of the trailer may be configured to act as roof rack crossbars. That is, each level may allow connection of racks or other equipment designed for use with vehicle rooftop racks. For instance, bike racks, cargo baskets, and/or rooftop tents may be secured to either the upper or the lower level.

The upper and lower levels of the trailer may be disposed at easily accessible heights. In other words, each level may be lower than a vehicle rooftop, thereby facilitating loading of heavy or unwieldy cargo. For example, the lower level may be disposed between approximately ankle height and knee height on a typical user, and the upper level may be disposed between waist height and chest height on a typical user. Cargo too heavy to be easily lifted to rooftop height may be secured on the lower level of the trailer with minimal lifting. Equipment that has a center of gravity difficult to lift in a balanced manner past a user's chest height may instead be loaded at approximately waist height on the upper level of the trailer.

The trailer may be configured to allow a variety of cargo to be secured, and to allow cargo to be secured in a variety of configurations. For example, cargo may be secured by equipment racks to the upper or lower level. The upper crossbars may include tie-down points, to facilitate securing cargo to the trailer with straps, ropes, ties, etc. The lower level of the trailer may be sufficiently wide to accommodate a cargo basket secured to the lower crossbars and/or to accommodate a sheet of plywood. Cargo may be carried on both the upper and lower levels simultaneously, and/or the upper crossbars may be removed to allow oversize cargo to be carried on the lower level. Cargo may include, but is not limited to, recreational equipment such as boats, bicycles, and camping gear, building materials such as lumber, pipe, and concrete, and work equipment such as mowers and ladders.

The hitch mount of the trailer may be disposed at a distal end of a tongue member, the tongue member being pivotably coupled to the central spine by a hinge device. The hinge device may be configured to be locked or otherwise secured with the tongue in an operational configuration, and to be released to allow the tongue to pivot to a storage configuration. In the operational configuration the tongue may extend substantially parallel to the central spine, and in the storage configuration the tongue may extend approximately perpendicular to the central spine.

The trailer may include suspension configured to protect carried cargo by improving ride quality. The suspension may be independent, and may include damping shocks. Each wheel assembly of the trailer may include a separate axle connected to the frame structure of the trailer by trailing-arm suspension. Each axle may also be connected to the frame structure by a coilover shock.

### Examples, Components, and Alternatives

The following sections describe selected aspects of exemplary trailers as well as related systems. The examples in these sections are intended for illustration and should not be interpreted as limiting the entire scope of the present disclosure. Each section may include one or more distinct embodiments or examples, and/or contextual or related information, function, and/or structure.

### A. Illustrative Double-Decker Trailer:

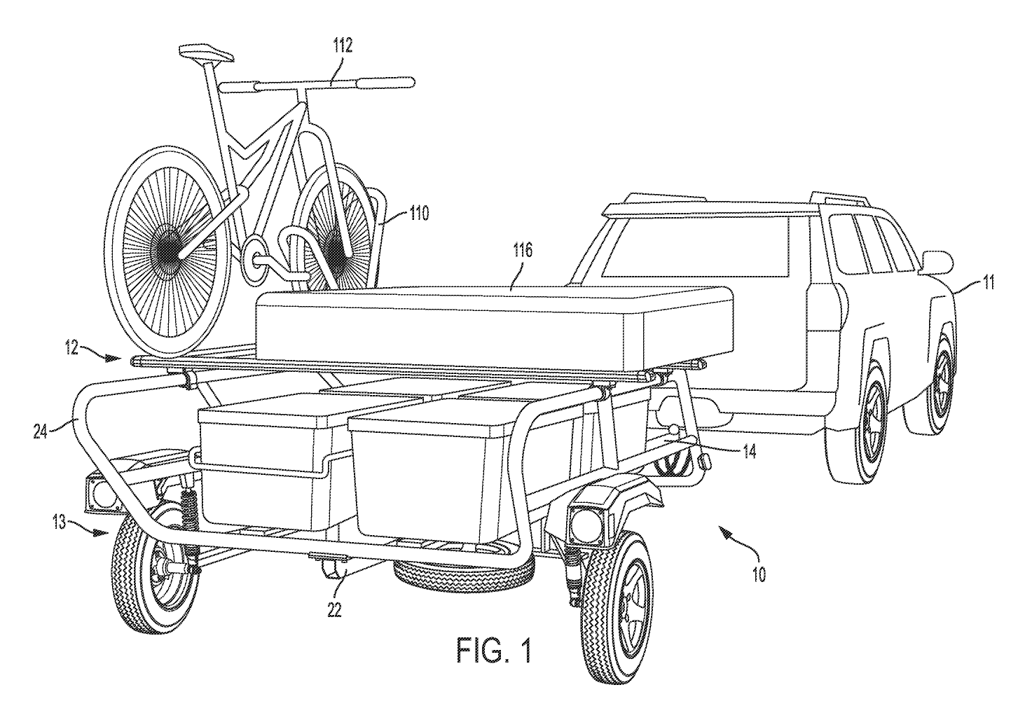

FIG. 1 shows a perspective view of a double-decker trailer 10, towed behind a vehicle 11. Trailer 10 is depicted carrying illustrative cargo including a bicycle, multiple storage bins, and a stowed rooftop tent. The trailer includes two cargo carrying levels, or decks. The bicycle and rooftop tent are secured to an upper deck 12 and the storage bins are stowed on a lower deck 13.

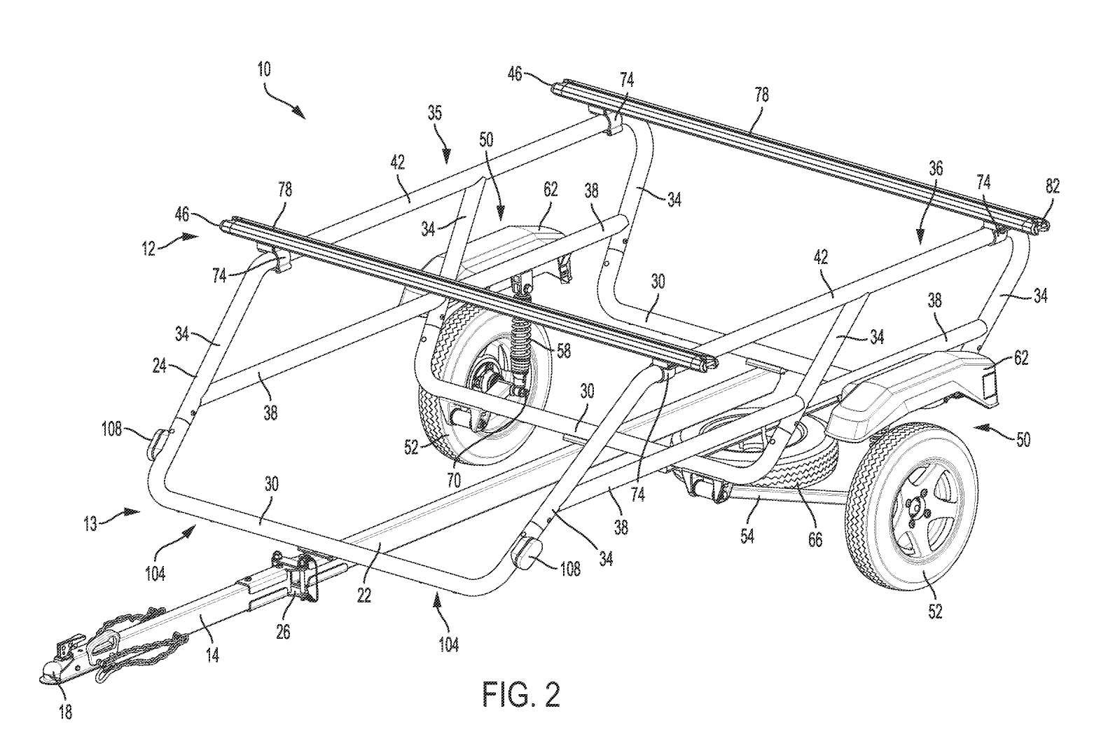

FIG. 2 shows an isometric view of trailer 10, including a tongue assembly 14, a central spine 22, and a frame structure 24. Tongue assembly 14 is configured for connection to a tow hitch of the vehicle, and includes a hitch ball coupler 18 at a distal end. Tongue assembly 14 may additionally or alternatively include any coupler or connectors appropriate to trailer towing.

A proximal end of the tongue assembly is pivotably connected to central spine 22 via a hinge device 26. The hinge device may selectively block tongue assembly 14 from pivoting when trailer 10 is in use, and permit pivoting of the tongue assembly to a more compact storage configuration. When in use, tongue assembly 14 is parallel to and coaxial with spine 22, while in the storage configuration the tongue assembly may be generally perpendicular to the spine.

Frame structure 24 includes three lower crossbars 30, each connected to central spine 22. In the present example, each crossbar is bolted to a curved plate welded to the spine. The lower crossbars are oriented perpendicular to the long axis of spine 22, and the direction of travel of trailer 10. Together, the three lower crossbars make up lower deck 13 of the trailer. Frame structure 24 further includes a total of six sloping struts, or side bars 34. Each side bar extends up from a curved end portion of a crossbar 30, and slopes rear-ward along the trailer. That is, each pair of sloping side bars 34 are connected to the end portions of a corresponding crossbar 30. Three of sloping side bars 34 define a first side portion 35 of frame structure 24, and the other three sloping side bars define a second side portion 36 of the frame structure.

Lower side rails 38 extend parallel to central spine 22, as part of first and second side portions 35, 36. The lower side rails are connected to intermediate portions of sloping side bars 34. In the present example, the trailer includes four lower side rails 38 with two lower side rails in each side portion. Each lower side rail extends between two sloping side bars 34. Upper side rails 42 similarly extend parallel to central spine 22, as part of first and second side portions 35, 36. The upper side rails are connected to upper end portions of sloping side bars 34. In the present example, the trailer includes two upper side rails 42, with one upper side rail defining a top edge of each side portion. Each upper side rail 42 spans between three sloping side bars 34.

In the present example, frame structure 24 is made up of hollow, circular members of extruded aluminum. Multiple separate sub-assemblies are bolted together to form the crossbars, side bars and side rails described above. Frame structure 24 may also be described as front, back, and middle upward U-shaped portions, each U-shaped portion having a pair of inclined arms. In some examples, the frame structure may be unitary, may be welded together, and/or may be constructed in any appropriate manner. The members may comprise any effective material, materials, and/or cross-sectional shape.

A pair of upper crossbars 46 are adjustably and removably coupled to upper side rails 42. A clamp device 74 connects each end portion of each crossbar to a corresponding side portion 35 or 36 of frame structure 24. Upper crossbars 46 define upper deck 12 of trailer 10. In the present example, trailer 10 includes 2 upper crossbars. In some examples, the trailer may include three or more upper crossbars and/or a user may add additional crossbars as needed.

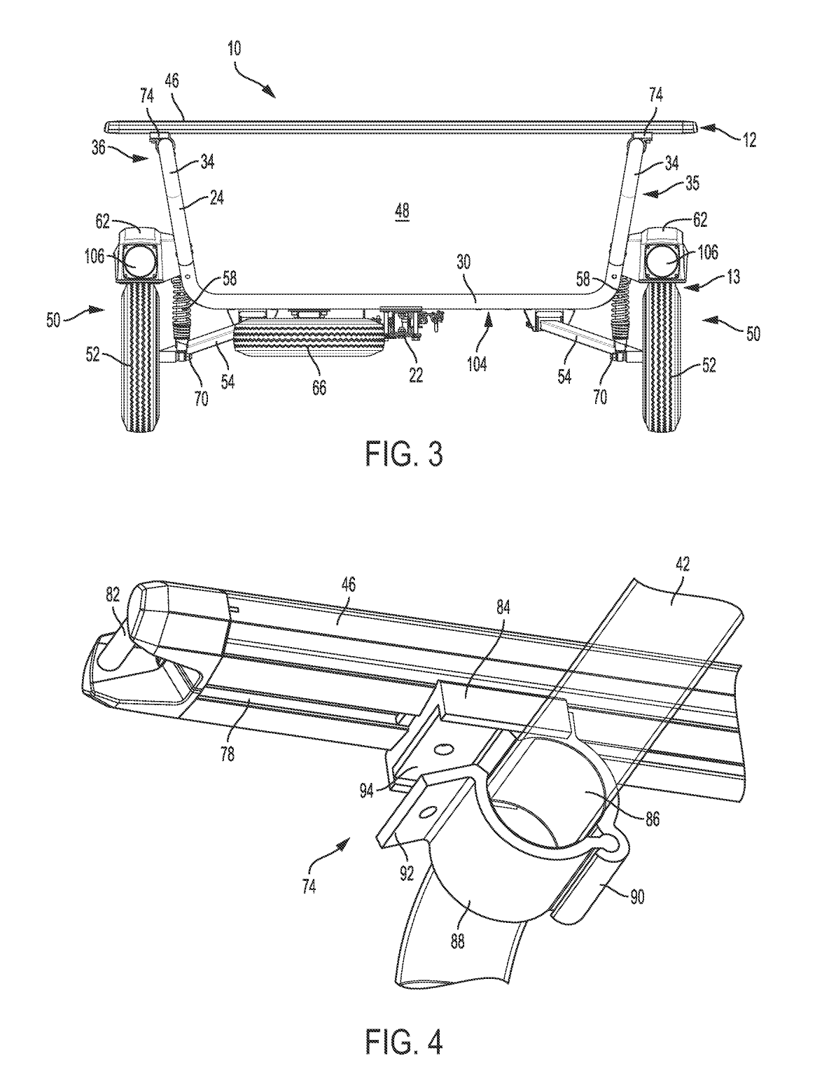

FIG. 3 is a rear view of trailer 10, showing an interior space 48 defined between upper deck 12 and lower deck 13. In other words, interior space 48 is roughly rectangular, with a vertical extent defined between lower crossbars 30 and upper crossbars 46, and a lateral extent defined between first side portion 35 and second side portion 36. Frame structure 24 may be sized according to typical cargo dimensions. For example, the lateral extent of interior space 48 may be at least four feet in order to accommodate a sheet of plywood. For another example, the vertical extent of interior space 48 may be at least three feet to accommodate common kayak depths. In some examples, upper crossbars 46 and/or lower crossbars 30 may have a curved, bent, or cornered shape. For instance, lower crossbars 30 may bend downward to a central linear region to define a larger interior space 48.

FIG. 4 shows a close-up view of one end of an upper crossbar 46 connected to an upper side rail 42 by a clamp device 74. The other upper crossbar to side rail connections may be matching, or matching but mirrored. Each crossbar 46 has a rounded rectangular cross-sectional shape, and may be configured for aerodynamic efficiency. The crossbar includes a longitudinal T-slot 78 on both upper and lower faces. The upper T-slot, shown in FIG. 2, may allow connection of accessory mounts to the crossbar. The lower T-slot is configured to engage clamp device 74. Each end of upper crossbar 46 is equipped with a tie down pin 82. The pin extends perpendicular to the crossbar, forming an aperture at the end of the crossbar.

Clamp device 74 is configured to allow longitudinal adjustment of upper crossbar 46 along upper side rail 42. The clamp device also allows lateral adjustment of the upper crossbar relative to the upper side rail. As shown in FIG. 4, the clamp device includes a traveler body 84, a fixed jaw 86, and a movable jaw 88. Traveler body 84 engages lower T-slot 78 of crossbar 46, preventing longitudinal movement between the crossbar and clamp device 74 while allowing the clamp device to slide laterally along the T-slot. That is, traveler body 84 may move along the length of crossbar 46, but may be prevented from moving perpendicular to the crossbar.

Fixed jaw 86 is formed at an inboard end of traveler body 84, extending down from the body. Movable jaw 88 is pivotably connected to fixed jaw 86 by a hinge joint 90. The movable jaw is pivotable from a closed position through a range of open positions. Clamp device 74 is depicted as partially open in FIG. 4, and is shown with moveable jaw 88 in the closed position in FIGS. 1-3, and 5. While clamp device 74 is open as shown in FIG. 4, crossbar 46 may be adjusted along upper side rail 42. The clamp device may be opened further to allow removal from the upper side rail.

Fixed jaw 86 and moveable jaw 88 each have a semi-circular inner surface, configured to contact approximately one half the circumference of the circular cross-section of upper side rail 42. When in a closed position, the two jaws may fully encircle a section of the upper side rail. In examples where upper side rail 42 has an alternate shape, fixed jaw 86 and moveable jaw 88 may have a corresponding shape. In some examples, the inner surfaces of fixed jaw 86 and moveable jaw 88 may include a compressible or high-grip material to improve frictional contact between the jaws and the upper side rail.

A tab 92 with an aperture is formed on a distal end of movable jaw 88. The tab is shaped to be received in a recess 94 of traveler body 84 when the moveable jaw is in the closed position. Recess 94 includes a corresponding aperture, extending entirely through the traveler body. The apertures in tab 92 and recess 94 may be threaded, and may align when the tab is received in the recess. To secure clamp device 74, a bolt may be threaded through the aligned apertures and tightened until an end of the bolt contacts an inner surface of lower T-slot 78 of crossbar 46. Contact between the bolt and crossbar 46 may prevent lateral motion of traveler body 84 relative to the crossbar. Contact between upper side rail 42 and the inner surfaces of fixed jaw 86 and movable jaw 88 may prevent longitudinal movement of crossbar 46 relative to the upper side rail.

Upper crossbars 46 may additionally or alternatively be secured to frame structure 24 by other types of clamps and/or connections. In some examples, crossbars 46 may form part of the frame structure. The upper crossbars may have the depicted cross-sectional shape, may match the circular shape of lower crossbars 30, and/or have any appropriate shape. Upper crossbars 46 may be adjustable laterally, adjustable longitudinally, removable, and/or permanently fixed.

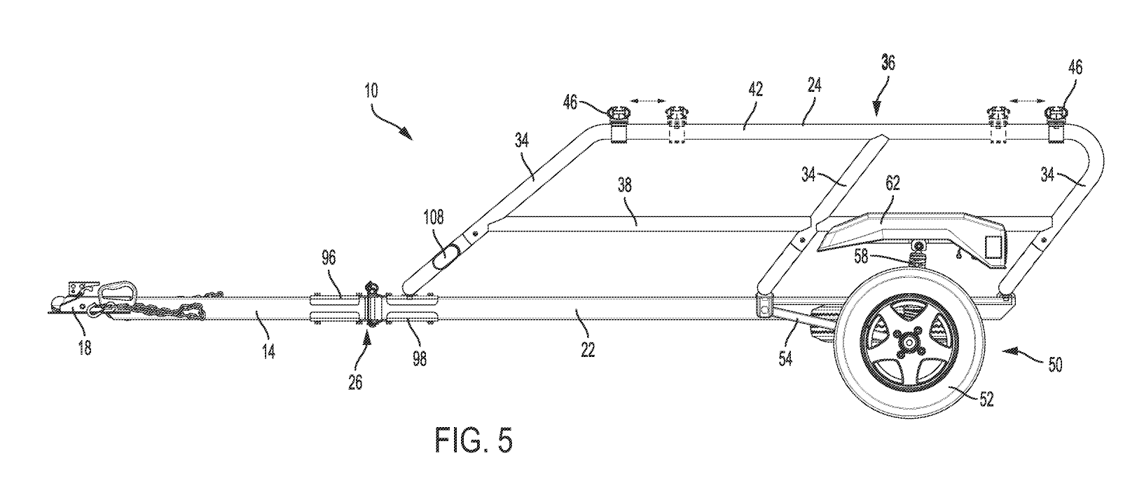

FIG. 5 shows a side view of trailer 10, with upper crossbars 46 depicted in a first spacing and a second spacing. A user of trailer 10 may adjust the longitudinal position of one or both crossbars by releasing the clamp device and sliding the crossbar along upper side rail 42. Adjusting the longitudinal position of one or both crossbars and/or the spacing between crossbars may allow a user greater flexibility in loading of cargo. For example, the spacing between upper crossbars 46 may be adjusted to match an equipment rack and allow connection of the rack to trailer 10. For another example, one of the upper crossbars may be adjusted out of the way of a tall portion of cargo loaded on the lower deck, such as the handlebars of a bicycle.

Also shown in FIG. 5 is a wheel assembly 50 of trailer 10, including a wheel 52 and a fender 62. A second wheel assembly can be seen in FIGS. 2 and 3. Each wheel assembly is disposed proximate a corresponding side portion 35 or 36 of frame structure 24. Wheel assemblies 50 may be described as aligned on a lateral axis of trailer 10, the axis being perpendicular to central spine 22. Wheel assemblies 50 are separately connected to frame structure 24, by independent suspension.

As shown in FIG. 3, each wheel 52 turns on an independent axle 70 supported by a trailing arm 54. A first end of trailing arm 54 is pivotably connected to axle 70 and a second end of the trailing arm is pivotably connected to central lower crossbar 30. Trailing arm 54 connects to central lower crossbar proximate an end portion of the lower crossbar. The trailing arm extends outboard from the connection to the crossbar, such that wheel 52 is disposed outboard of frame structure 24.

An inboard end of each axle 70 is also supported by a shock absorber 58. In the present example, shock absorber 58 is a coilover shock. One end of the shock is connected to the wheel axle, and the other end is connected to a respective lower side rail 38. Shock absorber 58 may also be described as suspending one end of the axle from the lower side rail. Fender 62 is also connected to an outboard side of lower side rail 38.

Trailer 10 may include any effective suspension, including independent and linked systems. The trailer may include any damping shocks, and/or may include any other features configured to improve ride quality. For example, wheels 52 may have tires with large sidewalls to smooth the ride of the trailer.

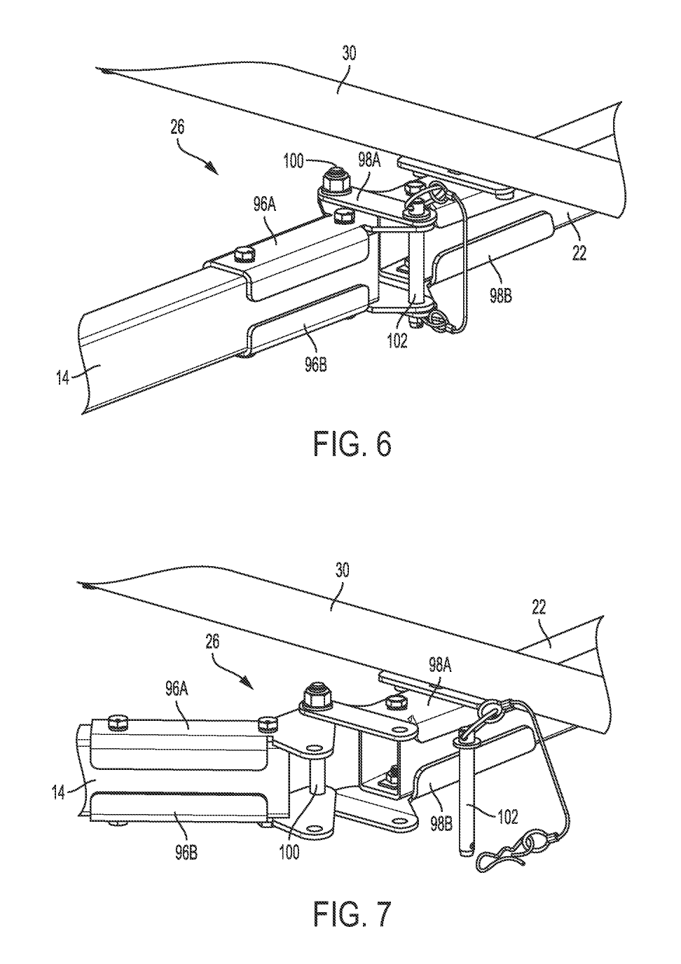

FIGS. 6 and 7 show a close-up view of hinge device 26, connecting tongue assembly 14 and central spine 22. The hinge device selectively allows tongue assembly 14 to pivot relative to spine 22, about an axis perpendicular to the direction of travel of the trailer. FIG. 6 shows hinge device 26 in a closed and locked position, while FIG. 7 shows the hinge device in an open and unlocked position.

Hinge device 26 includes a tongue-side hinge member 96 with a top plate 96A and a bottom plate 96B, each of which is bolted onto tongue 14. Similarly, the hinge device includes a spine-side member 98 with a top plate 98A and a bottom plate 98B bolted onto spine 22. Tongue 14 and spine 22 do not contact, but are spaced from each other. Each plate 96A, 96B, 98A, 98B extends out into the space between the tongue assembly and the central spine, flaring into an engaging portion. Additionally, spine-side top plate 98A extends slightly upward and spine-side bottom plate 98B extends slightly downward. The engaging portions of the top and bottom plates of tongue-side member 96 are therefore able to be received between the engaging portions of the top and bottom plates of spine-side member 98.

The engaging portion of each hinge member plate includes a pair of holes. Each pair of holes may be aligned with a corresponding pair of holes on the other hinge member. That is, the holes of tongue-side top plate 96A may be aligned with the holes of spine-side top plate 98A. Similarly, the holes of tongue-side bottom plate 98A may be aligned with the holes of spine-side bottom plate 98B.

A bolt 100 is fastened through one hole of each pair of holes. That is, one hole of each of top plate 96A, bottom plate 96B, top plate 98A, and 98B are aligned and bolt 100 extends through the four aligned holes. The bolt may be secured by a nut at one end, and/or may be permanently secured by welding or deformation of threads. Tongue assembly 14 may thereby pivot about bolt 100, relative to central spine 22.

The other hole of each tongue-side plate may be brought in and out of alignment with the corresponding holes in the spine-side plates as tongue assembly 14 pivots. When the tongue assembly is in a closed position as shown in FIG. 6, with tongue assembly 14 parallel to spine 22, the holes maybe aligned. A clevis pin 102 may be inserted to lock the tongue assembly in the closed position.

Tongue assembly 14 may also be connected to central spine 22 in any effective manner. In some examples, tongue assembly 14 and central spine 22 may be a single member. In some examples, hinge device 26 may further include a support member such as a kickstand, configured to support tongue assembly 14 and a forward end of trailer 10 when the trailer is not connected to a towing vehicle.

As indicated in FIGS. 2 and 3, lower crossbars 30 include multiple mounting points 104 for the attachment of trailer accessories. Each mounting point includes a pair of apertures in an underside of the crossbar, configured to receive fasteners such as bolts or screws. In the present example, each crossbar includes one mounting point 104 proximate each end portion of the crossbar. The rear and central lower crossbars 30 further include an additional two mounting points disposed further inboard. Trailer 10 may include any useful number of mounting points, disposed as is helpful for attachment of any structures or accessories.

Trailing arms 54 of wheel assemblies 50 are connected to central lower crossbar 30 at the outboard mounting points. A spare wheel assembly 66 is mounted to frame 24 by inboard mounting points 104 on the rear and central lower crossbars 30. The assembly includes a bar spanning between the two crossbars, with a spare wheel suspended below the bar. Other trailer accessories that may be connected to trailer 10 by one or more of mounting points 104 include, but are not limited to, kickstands, tiedown points, and license plate holders.

Trailer 10 further includes a wiring harness, not depicted in the drawings. FIGS. 2,3, and 5 do show brake lights 106 and indicator lights 108, which are connected to the wiring harness. Brake lights 106 are mounted on a rear side of fenders 62, and indicator lights 108 are mounted on outboard sides of the two forward-most sloping side bars 34. The wiring harness may run through the hollow members that make up frame structure 24, and through tongue assembly 14 to hitch coupler 18. The hitch coupler may also include a wiring adaptor configured for connection of the wiring harness to power and control of a towing vehicle.

FIGS. 1 and 8-10 depict multiple examples of cargo loaded on trailer 10. These examples are for illustration, and are not intended to limit the possible ways of securing cargo to the trailer, or the types of cargo that may be carried by the trailer.

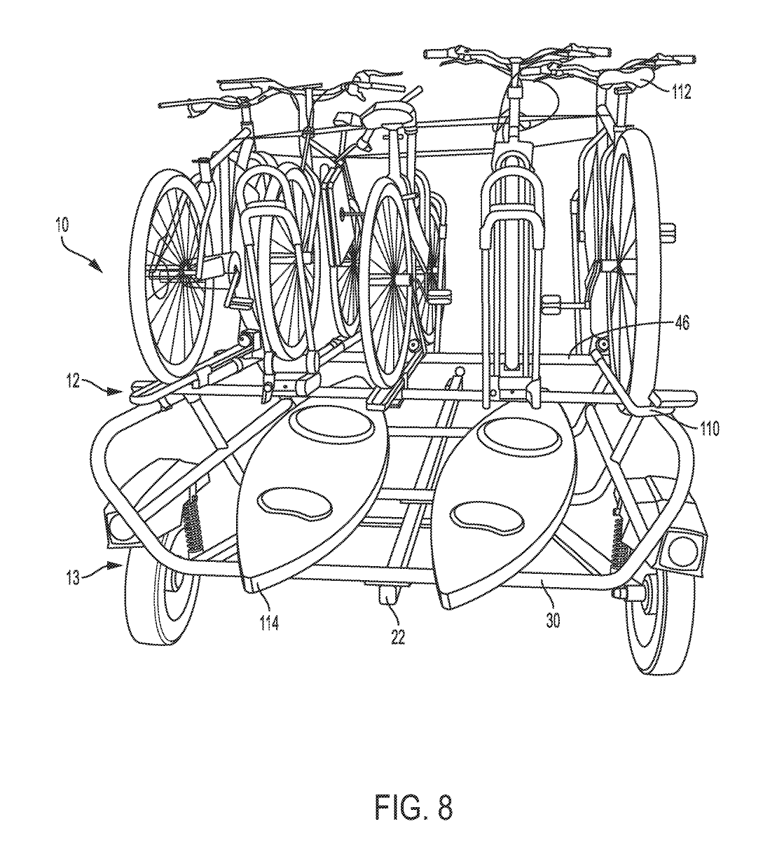

FIG. 8 shows a rear view of trailer 10 carrying five bicycles 112 and two kayaks 114. The bicycles are each secured by a bike rack 110, the bike racks in turn being connected to upper crossbars 46 of the trailer. Multiple bike rack styles are used, as appropriate to the varying sizes and types of the secured bicycles. Each bike rack 110 is a standard rack, compatible with crossbars of a vehicle roof rack.

Kayaks 114 are loaded on lower deck 13 of the trailer. As shown, the kayaks rest directly on lower crossbars 30. The kayaks may also be secured by a boat saddle set and/or rollers. Straps or ties may be used to restrain the kayaks during transport. For example, straps may be looped around lower crossbars 30 and tied to the tie-down pins at the ends of upper crossbars 46, and/or tied directly to the frame structure of the trailer.

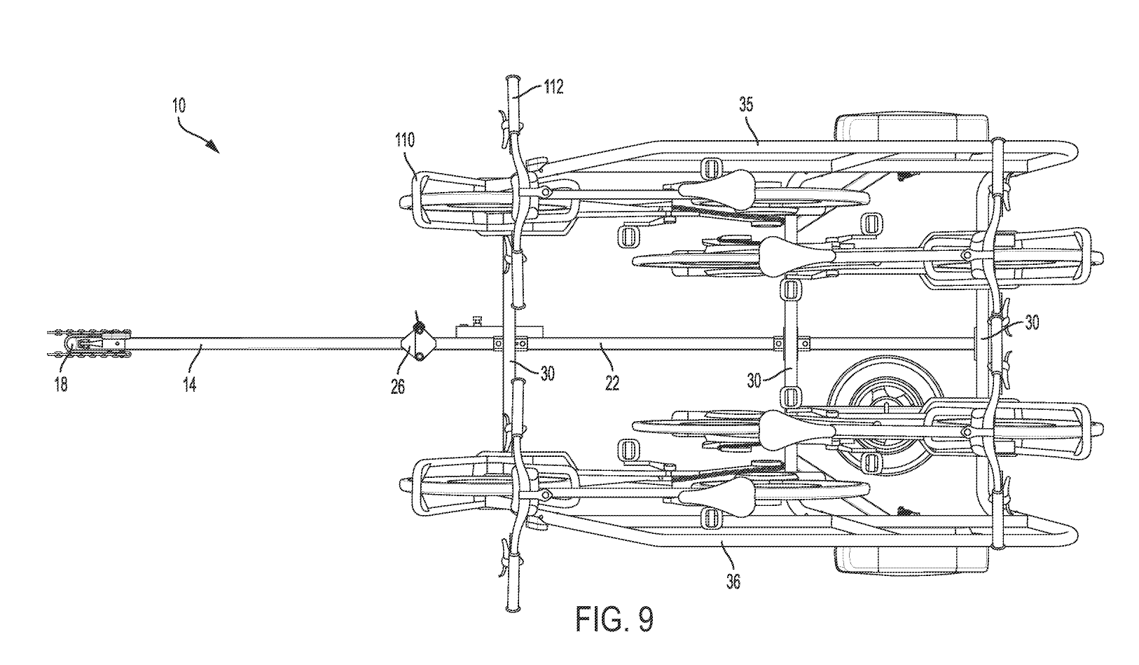

FIG. 9 shows a top view of trailer 10 carrying four bicycles 112. The upper crossbars have been removed by releasing the clamp devices, and may be stored separately or transported in the towing vehicle. The four bicycles are of matching size and style, and are secured by matching bike racks 110. The bike racks may include round-bar adaptors to facilitate connection to the round lower crossbars.

Each bike rack is connected to and spanning between two lower crossbars 30, either the rear and central lower crossbars or the forward and central lower crossbars. This utilization of the three lower crossbars may prevent conflict between handlebars, pedals and such portions of the loaded bicycles. Side portions 35 and 36 of the frame structure may provide additional security for the bicycles, which may also be secured to the frame structure by straps, ties, etc. It may be noted that bicycles 112 and bike racks 110 extend longitudinally beyond frame structure 24. The open ends of trailer 10 may allow for oversize cargo and/or load configurations such as illustrated in FIG. 9.

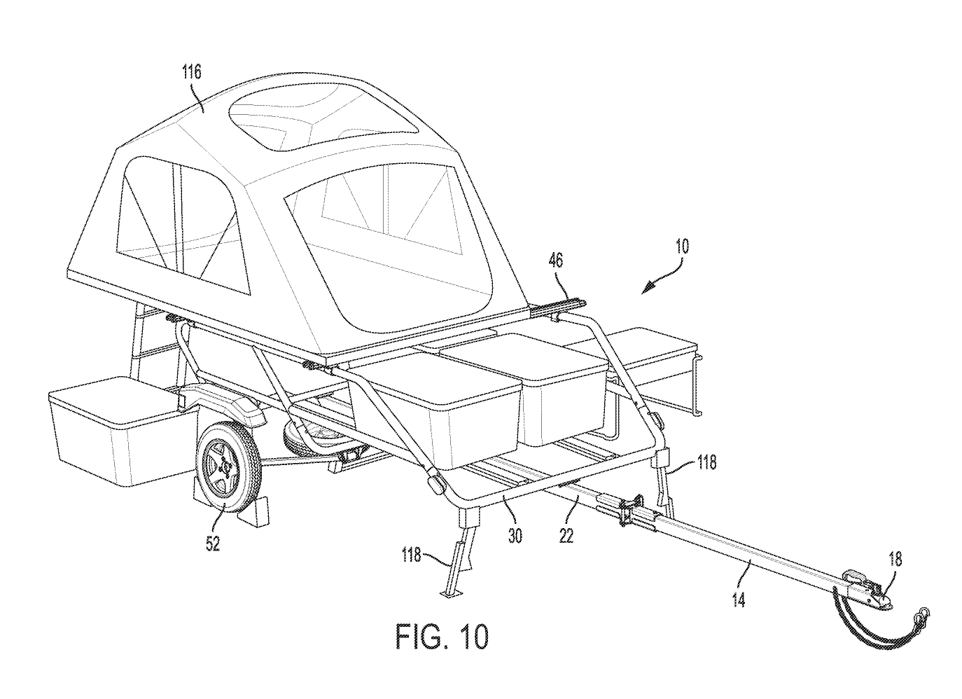

FIG. 10 shows trailer 10 parked, with a rooftop tent 116 set up on the upper deck. Stands, or tent jacks 118 are mounted at corners of the frame structure, on lower crossbars 30. The jacks may be mounted once trailer 10 has been parked or may be configured to remain connected and to fold up against crossbar 30 when not in use. Tent jacks 118 may stabilize trailer 10, allowing the trailer to provide a solid base for the tent. Wheels 52 are also chocked to prevent unwanted motion.

Ample space for camping gear and supplies is provided by the storage bins transported on the lower deck. Such storage may be accommodated by a cargo basket or other storage solution connected to lower crossbars 30. In the present example, a track system spans between the lower crossbars, and the storage bins are configured to slot into the track.

Rooftop tent 116 is connected to upper crossbars 46, and erected for use. The tent's ladder is extended at the rear of the trailer for access. During transport on trailer 10, the tent may be stowed as shown in FIG. 1. Use of rooftop tent 116 may provide the usual advantages of elevation and ease of erection of a rooftop tent, while eliminating some of the usual disadvantages. For example, rooftop tent 116 may be left connected to trailer 10 when not in use, without impacting aerodynamics and daily fuel efficiency of the user's vehicle. Rooftop tent 116 may also be left erected while the towing vehicle is used elsewhere, allowing a campsite to remain set up while the campers leave for a day hike or other activities.

### B. Illustrative Single-Decker Trailer:

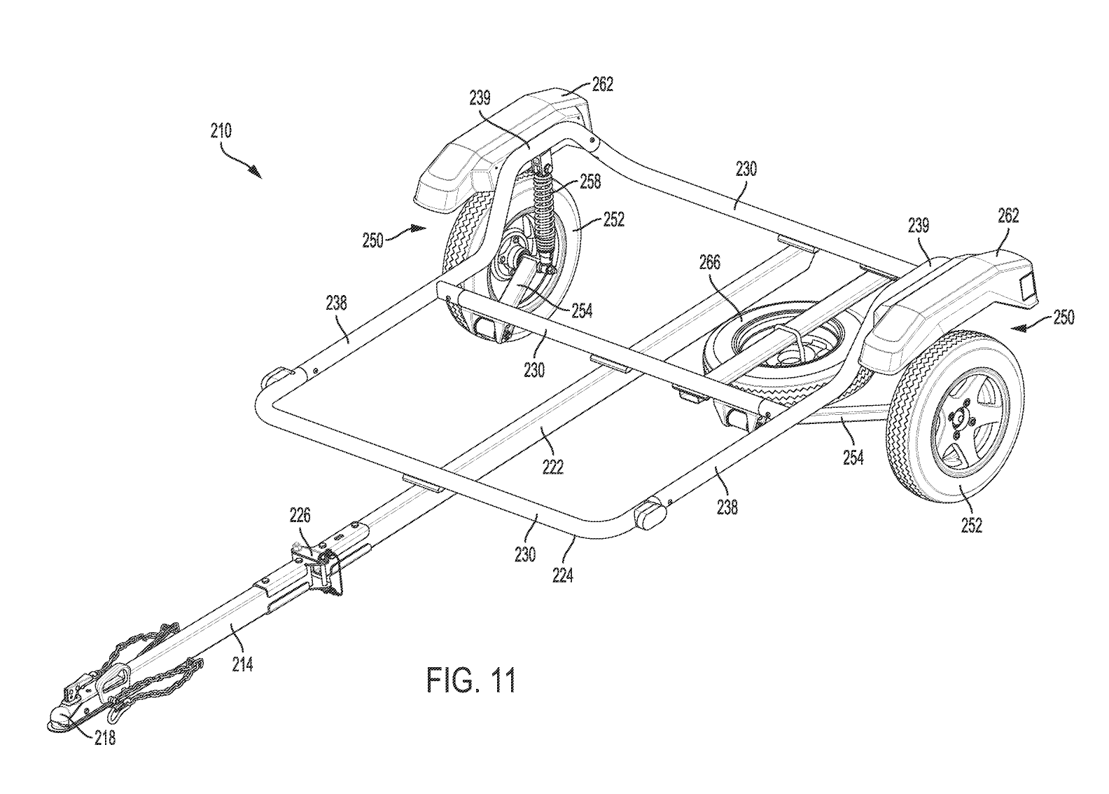

FIG. 11. shows another example of a trailer 210, also including a tongue assembly 214, a central spine 222, and a frame structure 224. Tongue assembly 214 is configured for connection to a vehicle hitch, and includes a hitch ball coupler 218 at a distal end. A proximal end of the tongue assembly is pivotably connected to central spine 222 via a hinge device 226. The hinge device may selectively block tongue assembly 214 from pivoting when trailer 210 is in use, and permit pivoting of the tongue assembly to a more compact storage configuration.

Frame structure 224 includes a plurality of crossbars 230, orthogonally connected to central spine 222. Side rails 238 span between crossbars 230, parallel to spine 222 and connecting the end portions of the crossbars. Each side rail 238 includes a raised section 239 proximate a respective wheel assembly 250.

Each wheel assembly 250 includes a wheel 252, which has an independent axle connected to one end of a trailing arm 254. The other end of each trailing arm 254 is pivotably connected to central crossbar 230. A coilover shock 258 suspends an inboard end of each axle from raised section 239 of respective side rail 238. Fenders 262 are attached to an outboard side of raised sections 239 of side rails 238. A spare wheel 266 is suspended from a bar spanning between rear and central crossbars 230.

Trailer 210 may be described as a single-decker trailer, having one deck formed by crossbars 230.

### Additional Examples and Illustrative Combinations

This section describes additional aspects and features of a vehicle hitch mounting trailer according to the present teachings, and related systems and methods, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A. A vehicle trailer, comprising:

a tongue portion configured for connection to a tow hitch of a vehicle,

a spine portion connected to the tongue portion,

a frame structure including a plurality of lower crossbar members transversely connected to the spine portion, the lower crossbars defining a first cargo support level, and

a plurality of upper crossbar structures connected to the frame structure above the first cargo support level, the upper crossbar structures defining a second cargo support level elevated above the first cargo support level.

A1. The vehicle trailer of A, wherein each lower crossbar member is connected to a pair of inclined strut members, the inclined strut members being connected to a pair of side rails, the upper crossbar structures being supported by the pair of side rails.

A2. The vehicle trailer of A, wherein the tongue portion is connected to the spine portion by a hinge mechanism.

A3. The vehicle trailer of A, wherein each upper crossbar structure includes a t-slot configured for mounting an accessory rack component.

A4. The vehicle trailer of A, further comprising:

a tent mounted on the upper crossbar structures, and

cargo containers mounted on the lower crossbar members.

A5. The vehicle trailer of A, further comprising:

a pair of independently suspended wheels connected to the frame structure.

A6. The vehicle trailer of A, wherein the frame structure has at least three lower crossbar members.

A7. The vehicle trailer of A, further comprising at least one jack device for supporting the frame structure when the trailer is not connected to a vehicle.

A8. The vehicle trailer of A, wherein each upper crossbar structure of the plurality of upper crossbar structures is adjustable along the frame structure.

A9. The vehicle trailer of A, wherein the plurality of upper crossbar structures includes two or more removable upper crossbar structures.

B. A vehicle trailer, comprising:

a tongue portion configured for connection to a tow hitch of a vehicle,

a spine portion connected to the tongue portion, and

a frame structure including a plurality of lower crossbar members transversely connected to the spine, the lower crossbars defining a first cargo support level, wherein each of the lower crossbar members has opposing end portions connected to side strut members rising to connection with a pair of upper side rail portions on opposing sides of the frame structure.

B1. The vehicle trailer of B, wherein the tongue portion is connected to the spine portion by a hinge mechanism.

B2. The vehicle trailer of B, wherein the frame structure has at least three lower crossbar members.

B3. The vehicle trailer of B, wherein the frame structure includes a pair of lower side rails below and parallel to the pair of upper side rails.

B4. The vehicle trailer of B, wherein the frame structure has at least three side strut members per side.

C. A vehicle trailer, comprising:

a tongue portion configured for connection to a tow hitch of a vehicle,

a spine portion connected to the tongue portion,

a frame structure including front and back upward U-shaped portions connected to the spine portion, the front and back U-shaped portions being connected to a pair of side rails, and

a pair of crossbars mounted on the side rails.

C1. The vehicle trailer of C, wherein each U-shaped portion has a pair of inclined arms.

C2. The vehicle trailer of C, wherein the tongue portion is connected to the spine portion by a hinge mechanism.

C3. The vehicle trailer of C, wherein the frame structure includes a middle U-shaped portion between the front and back U-shaped portions.

C4. The vehicle trailer of C, further comprising:

a pair of independently suspended wheels connect to the frame structure.

C5. The vehicle trailer of C, further comprising:

a tent mounted on the crossbars.

C6. The vehicle trailer of C, wherein the frame structure includes a pair of lower side rails below and parallel to the pair of upper side rails.

### Conclusion

It is believed that the disclosure set forth herein encompasses multiple distinct inventions with independent utility. While each of these inventions has been disclosed in its preferred form, the specific examples thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities.

Although the present disclosure has been provided with reference to the foregoing operational principles and examples, it will be apparent to those skilled in the art that various changes in form and detail may be made without departing from the spirit and scope of the disclosure. The present disclosure is intended to embrace all such alternatives, modifications and variances. Furthermore, any aspect shown or described with reference to a particular example should be interpreted to be compatible with any other example, alternative, modification, or variance.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

What is claimed is:

1. A vehicle trailer, comprising:
a tongue portion configured for connection to a tow hitch of a vehicle,
a spine portion connected to the tongue portion,
a frame structure including a plurality of lower crossbar members transversely connected to the spine portion, the lower crossbars defining a first cargo support level, and
a plurality of upper crossbar structures connected to the frame structure above the first cargo support level, the upper crossbar structures defining a second cargo support level elevated above the first cargo support level.

2. The vehicle trailer of claim 1, wherein each lower crossbar member is connected to a pair of inclined strut members, the inclined strut members being connected to a pair of side rails, the upper crossbar structures being supported by the pair of side rails.

3. The vehicle trailer of claim 1, wherein the tongue portion is connected to the spine portion by a hinge mechanism.

4. The vehicle trailer of claim 1, wherein each upper crossbar structure includes a t-slot configured for mounting an accessory rack component.

5. The vehicle trailer of claim 1, wherein each upper crossbar structure of the plurality of upper crossbar structures is adjustable along the frame structure.

6. The vehicle trailer of claim 1, further comprising:
a pair of independently suspended wheels connected to the frame structure.

7. The vehicle trailer of claim 1, wherein the plurality of upper crossbar structures includes two or more removable upper crossbar structures.

8. The vehicle trailer of claim 1, further comprising at least one jack device for supporting the frame structure when the trailer is not connected to a vehicle.

9. A vehicle trailer, comprising:
a tongue portion configured for connection to a tow hitch of a vehicle,
a spine portion connected to the tongue portion, and
a frame structure including a plurality of lower crossbar members transversely connected to the spine, the lower crossbars defining a first cargo support level, wherein each of the lower crossbar members has opposing end portions connected to side strut members rising to connection with a pair of upper side rail portions on opposing sides of the frame structure.

10. The vehicle trailer of claim 9, wherein the tongue portion is connected to the spine portion by a hinge mechanism.

11. The vehicle trailer of claim 9, wherein the frame structure has at least three lower crossbar members.

12. The vehicle trailer of claim 9, wherein the frame structure includes a pair of lower side rails below and parallel to the pair of upper side rails.

13. The vehicle trailer of claim 9, wherein the frame structure has at least three side strut members per side.

14. A vehicle trailer, comprising:
a tongue portion configured for connection to a tow hitch of a vehicle,
a spine portion connected to the tongue portion,
a frame structure including front and back upward U-shaped portions connected to the spine portion, the front and back U-shaped portions being connected to a pair of side rails, and
a pair of crossbars mounted on the side rails.

15. The vehicle trailer of claim 14, wherein each U-shaped portion has a pair of inclined arms.

16. The vehicle trailer of claim 14, wherein the tongue portion is connected to the spine portion by a hinge mechanism.

17. The vehicle trailer of claim 14, wherein the frame structure includes a middle U-shaped portion between the front and back U-shaped portions.

18. The vehicle trailer of claim 14, further comprising:
a pair of independently suspended wheels connect to the frame structure.

19. The vehicle trailer of claim 14, further comprising:
a tent mounted on the crossbars.

20. The vehicle trailer of claim 14, wherein the frame structure includes a pair of lower side rails below and parallel to the pair of upper side rails.
